(19) United States
(12) Patent Application Publication
(10) Pub. No.: US 2018/0041103 A1
(43) Pub. Date: Feb. 8, 2018

(54) SQUIRREL-CAGE ROTOR, ELECTRIC MOTOR AND WASHING MACHINE

(71) Applicant: FOSHAN WEILING WASHER MOTOR MANUFACTURING CO., LTD., Foshan, Guangdong (CN)

(72) Inventors: Haiquan Xiao, Foshan, Guangdong (CN); Hongxiao Wang, Foshan, Guangdong (CN); Yinhu LIU, Foshan, Guangdong (CN); Junjie Hu, Foshan, Guangdong (CN); Lifeng Zhang, Foshan, Guangdong (CN)

(21) Appl. No.: 15/501,090

(22) PCT Filed: May 25, 2016
(86) PCT No.: PCT/CN2016/083361

§ 371 Date: Feb. 1, 2017

(30) Foreign Application Priority Data
Dec. 22, 2015 (CN) 201510979139.X

(51) Int. Cl. H02K 17/16; D06F 37/30

(52) U.S. Cl. CPC H02K 17/165; D06F 37/304

(57) ABSTRACT

A squirrel-cage rotor, an electric motor and a washing machine are provided. The squirrel-cage rotor includes a rotor core, a squirrel-cage guide bar and a squirrel-cage short-circuit ring. The rotor core is provided with a rotor groove penetrating through an end surface of the rotor core. The squirrel-cage guide bar is provided in the rotor groove. The squirrel-cage short-circuit ring is provided on the end surface of the rotor core and is connected to the squirrel-cage guide bar, in which a height of the squirrel-cage short-circuit ring in an axial direction of the rotor core is denoted as H. A minimum inner diameter of the squirrel-cage short-circuit ring is denoted as D1. A maximum outer diameter of the squirrel-cage short-circuit ring is denoted as D2, and wherein 7 mm≦H≦14 mm and 0.53≦D1/D2≦0.78.

### CROSS-REFERENCE TO RELATED APPLICATION

The present application is a national phase entry under 35 USC §371 of International Application PCT/CN2016/083361, filed May 25, 2016, which claims the benefit of and priority to Chinese Patent Application No. 201510979139.X, filed Dec. 22, 2015, the entire disclosures of which are incorporated herein by reference.

### FIELD

The present disclosure relates to a technical field of manufacture of electric motors, and more particularly to a squirrel-cage rotor, an electric motor having the squirrel-cage rotor and a washing machine having the electric motor.

### BACKGROUND

A washing machine in the related art adopts a squirrel-cage electric motor to drive a dewatering tub to rotate. However, the squirrel-cage electric motor has high material cost, and low manufacturing pass rate and production efficiency.

### SUMMARY

The present invention is based on findings of the inventor of the present application regarding the following facts and problems:

In the related art, a washing machine adopts a squirrel-cage electric motor to drive a dewatering tub to rotate; the squirrel-cage electric motor needs to operate at an adjustable speed in a range of 0 to 18000 rpm; and power is transmitted through a belt between the electric motor and the dewatering tub. When the speed of the dewatering tub reaches 1400 rpm, the corresponding speed of the electric motor exceeds 15000 rpm. At this time the squirrel-cage electric motor is in a high speed operation state, and if there is a large unbalance of the rotor, severe vibrations of the electric motor will take place, thereby causing huge noises and vibrations of the washing machine, influencing daily use, and reducing a service life of the washing machine. Hence, a dynamic balance processing is generally required for the rotor of the squirrel-cage electric motor used in the washing machine.

Currently, two main ways for the dynamic balance processing are lightening and weighting. Since the lightening way is of high reliability and is easily mechanized, it has been widely adopted. The specific dynamic balance lightening processing way is to provide a dynamic balance lightening hole in an aluminum squirrel-cage short-circuit ring of the squirrel-cage rotor. Due to a relatively small density of aluminum, a diameter of the dynamic balance lightening hole needs to be made relatively large in order to meet a lightening requirement of a high-precision dynamic balance. Meanwhile, in order to ensure that a performance of the electric motor is not affected by the dynamic balance lightening hole, a certain distance between the dynamic balance lightening hole and a rotor core needs to be ensured. Accordingly, a height and a thickness of the squirrel-cage short-circuit ring of this kind of variable frequency electric motor are required to be made very large, and an amount of aluminum used for the squirrel-cage rotor is large, which results in a high material cost of the electric motor. Furthermore, due to a large amount of cast aluminum, an interior of the cast aluminum easily encounters die casting defects such as gas porosity, during a die casting process, and a die casting mold may not achieve a design of more than four cavities (four parts can be made at once with one mold), which results in low qualification rate and production efficiency of the electric motor.

The present invention is intended to solve at least one of technical problems in the related art. To this end, the present invention needs to provide a squirrel-cage rotor, which not only meets the lightening requirement of the dynamic balance, but also meets the performance requirement of the electric motor, and further has low material cost, high die casting qualification rate and production efficiency.

The present invention also needs to provide an electric motor having the squirrel-cage rotor.

The present invention further needs to provide a washing machine having the electric motor.

The squirrel-cage rotor according to embodiments of a first aspect of the present invention, includes a rotor core provided with a rotor groove penetrating through an end surface of the rotor core; a squirrel-cage guide bar provided in the rotor groove; and a squirrel-cage short-circuit ring providing on the end surface of the rotor core and connected to the squirrel-cage guide bar, in which a height of the squirrel-cage short-circuit ring in an axial direction of the rotor core is denoted as H, a minimum inner diameter of the squirrel-cage short-circuit ring is denoted as D1, a maximum outer diameter of the squirrel-cage short-circuit ring is denoted as D2, and 7 mm≦H≦14 mm, 0.53≦D1/D2≦0.78.

The squirrel-cage rotor according to embodiments of the present invention may not only meet the lightening requirement of the dynamic balance, but also meet the performance requirement of the electric motor, and further the amount of material used is small, the die casting mold may achieve six cavities, such that the material cost is low, the die casting qualification rate and production efficiency is high.

In addition, the squirrel-cage rotor according to embodiments of the present invention further has additional technical features as follows:

According to some embodiments of the present invention, at least one of an inner circumferential surface, an outer circumferential surface, and an end surface, far away from the rotor core, of the squirrel-cage short-circuit ring is provided with a dynamic balance lightening hole.

Optionally, a diameter of the dynamic balance lightening hole is 3 to 6 mm.

Preferably, the dynamic balance lightening hole is provided in at least one of the inner circumferential surface and the outer circumferential surface of the squirrel-cage short-circuit ring, and the diameter of the dynamic balance lightening hole is 5 mm.

According to some embodiments of the present invention, the height H of the squirrel-cage short-circuit ring in the axial direction of the rotor core is 12 mm, and the ratio D1/D2 of the minimum inner diameter of the squirrel-cage short-circuit ring to the maximum outer diameter of the squirrel-cage short-circuit ring is 0.66.

According to some embodiments of the present invention, a cross section of the squirrel-cage short-circuit ring is a trapezoid.

Further, a long base of the trapezoid is adjacent to the rotor core, and a short base of the trapezoid is far away from the rotor core.

According to some embodiments of the present invention, the squirrel-cage guide bar is oriented in the axial direction of the rotor core or is inclined with respect to the axial direction of the rotor core.

According to some embodiments of the present invention, the squirrel-cage guide bar and the squirrel-cage short-circuit ring are formed integrally.

According to some embodiments of the present invention, the rotor core is formed by laminating a plurality of rotor punching sheets.

The electric motor according to embodiments of a second aspect of the present invention, includes a stator; a rotor, in which the rotor is a squirrel-cage rotor according to the above-described first aspect embodiments of the present invention, and the squirrel-cage rotor is rotatably provided in the stator; and at least one end cap for mounting the stator and the rotor.

The electric motor according to embodiments of the present invention, by utilizing the above-described squirrel-cage rotor, may meet dynamic balance processing requirements, and have an excellent performance, a low material cost, a high die casting qualification rate and production efficiency.

The washing machine according to embodiments of a third aspect of the present invention, includes a rotatable dewatering tub; and an electric motor, in which the electric motor is an electric motor according to the above-described embodiments of the second aspect of the present invention, and the electric motor is in a transmission connection with the dewatering tub to drive the dewatering tub to rotate.

The washing machine according to embodiments of the present invention, by utilizing the accompanying drawings electric motor, may achieve small noises and vibrations, and a long service life.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

FIG. 1 is a schematic view of a structure of an electric motor according to an embodiment of the present invention;

FIG. 2 is an exploded view of an electric motor according to an embodiment of the present invention;

FIG. 3 is schematic view of a structure of a squirrel-cage rotor according to an embodiment of the present invention;

FIG. 4 is a sectional view of a squirrel-cage rotor according to an embodiment of the present invention;

FIG. 5 is a schematic view of a structure of a rotor punching sheet of a squirrel-cage rotor according to an embodiment of the present invention.

### REFERENCE NUMERALS

1: electric motor;
100: squirrel-cage rotor;
110: rotor core;
111: rotor groove;
112: rotor punching sheet;
1120: punching groove;
120: squirrel-cage short-circuit ring;
200: stator;
300: end cap.

### DETAILED DESCRIPTION

Hereinafter, embodiments of the present disclosure will be described in detail, and examples of the embodiments are illustrated in accompanying drawings, in which the same or similar elements and the elements having same or similar functions are denoted by like reference numerals. The embodiments described herein with reference to drawings are exemplary, only used to generally understand the present disclosure, and shall not be construed to limit the present disclosure.

The present invention is based on findings of the inventor of the present application regarding the following facts and problems:

In the related art, a washing machine adopts a squirrel-cage electric motor to drive a dewatering tub to rotate; the squirrel-cage electric motor needs to operate at an adjustable speed in a range of 0 to 18000 rpm; and power is transmitted through a belt between the electric motor and the dewatering tub. When the speed of the dewatering tub reaches 1400 rpm, the corresponding speed of the electric motor exceeds 15000 rpm. At this time the squirrel-cage electric motor is in a high speed operation state, and if there is a large unbalance of the rotor, severe vibrations of the electric motor will take place, thereby causing high noises and vibrations of the washing machine, influencing daily use, and reducing a service life of the washing machine. Hence, a dynamic balance processing is generally required for the rotor of the squirrel-cage electric motor used in the washing machine.

Currently, two main ways for the dynamic balance processing are lightening and weighting. Since the lightening way is of high reliability and is easily mechanized, it has been widely adopted. The specific dynamic balance lightening processing way is to provide a dynamic balance lightening hole in an aluminum squirrel-cage short-circuit ring of the squirrel-cage rotor. Due to a relatively small density of aluminum, a diameter of the dynamic balance lightening hole needs to be made relatively large in order to meet a lightening requirement of a high-precision dynamic balance. Meanwhile, in order to ensure that a performance of the electric motor is not affected by the dynamic balance lightening hole, a certain distance between the dynamic balance lightening hole and a rotor core needs to be ensured. Accordingly, a height and a thickness of the squirrel-cage short-circuit ring of this kind of variable frequency electric motor are required to be made very large, and an amount of aluminum used for the squirrel-cage rotor is large, which results in a high material cost of the electric motor. Furthermore, due to a large amount of cast aluminum, an interior of the cast aluminum easily encounters die casting defects such as gas porosity, during a die casting process, and a die casting mold may not achieve a design of more than four cavities (four parts can be made at once with one mold), which results in low qualification rate and production efficiency of the electric motor.

To this end, the present invention is to provide a squirrel-cage rotor 100 used in a washing machine for driving a dewatering tub of the washing machine to rotate, which not only meets the lightening requirement of the dynamic balance, but also meets the performance requirement of the electric motor, and further has low material cost, high die casting qualification rate and production efficiency.

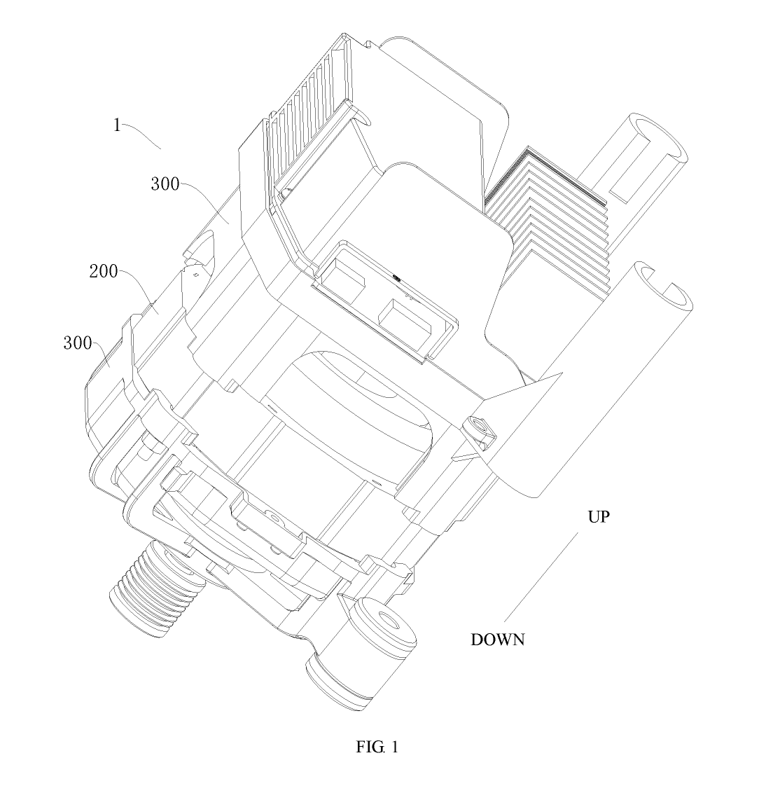

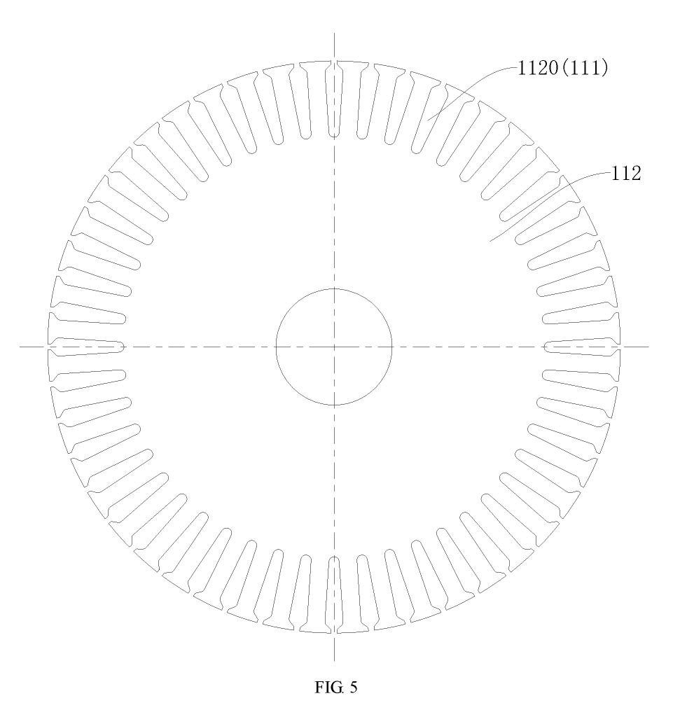

Hereinafter, the squirrel-cage rotor 100 according to embodiments of a first aspect of the present invention will be described with reference to FIGS. 1 to 5.

As shown in FIGS. 1 to 5, the squirrel-cage rotor 100 according to embodiments of the present invention includes a rotor core 110, a squirrel-cage guide bar (not illustrated) and a squirrel-cage short-circuit ring 120.

An outer circumferential surface of the rotor core 110 is provided with a plurality of rotor grooves 111, the plurality of rotor grooves 111 are equidistantly spaced in a circumferential direction of the rotor core 110, and each rotor groove 111 penetrates through the rotor core 110 in an axial direction of the rotor core 110, i.e. both ends of each rotor groove 111 penetrate through both end surfaces of the rotor core 110 respectively. A plurality of squirrel-cage guide bars are provided and disposed in the plurality of rotor grooves 111 respectively. Two squirrel-cage short-circuit rings 120 are provided and disposed on both end surfaces of the rotor core 110 respectively, and each squirrel-cage short-circuit ring 120 is connected to the plurality of squirrel-cage guide bars to constitute a short-circuit winding. Preferably, the squirrel-cage short-circuit ring 120 is an aluminum ring. A height of the squirrel-cage short-circuit ring 120 in the axial direction of the rotor core 110 (refer to an up-and-down direction as shown in figures) is denoted as H, a minimum inner diameter of the squirrel-cage short-circuit ring 120 is denoted as D1, and a maximum outer diameter of the squirrel-cage short-circuit ring 120 is denoted as D2, such that at least one of the two squirrel-cage short-circuit rings 120 meets conditions: 7 mm≦H≦14 mm, 0.53≦D1/D2≦0.78. Preferably, the two squirrel-cage short-circuit rings 120 both meet 7 mm≦H≦14 mm and 0.53≦D1/D2≦0.78.

In this way, the height H of the squirrel-cage short-circuit ring 120 in the axial direction of the rotor core 110 and the thickness thereof in a radial direction of rotor core 110 are smaller with respect to the squirrel-cage short-circuit ring in related art, which thus not only reduces an amount of material used to reduce the material cost, but also avoids die casting defects such as gas porosity, during the die casting process, such that the die casting mold may achieve six cavities (six parts can be made at once with one mold), which thus improves the die casting qualification rate and production efficiency of the squirrel-cage rotor 100. Furthermore, when the dynamic balance processing is performed, the diameter of the dynamic balance lightening hole can be made relatively large to meet the lightening requirement of the high-precision dynamic balance. Meanwhile, the height H of the squirrel-cage short-circuit ring 120 in the axial direction of the rotor core 110 can ensure an enough distance between the dynamic balance lightening hole and the rotor core 110, which thus prevents the dynamic balance lightening hole from affecting the performance of the electric motor.

In summary, the squirrel-cage rotor 100 according to embodiments of the present invention, the height H of the squirrel-cage short-circuit ring 120 in the axial direction of the rotor core 110 is designed to be in a range between 7 mm and 14 mm, and a ratio of the minimum inner diameter D1 of the squirrel-cage short-circuit ring 120 to the maximum outer diameter D2 thereof is designed to be in a range between 0.53 and 0.78, such that the squirrel-cage rotor 100 may not only meet the lightening requirement of the dynamic balance, but also meet the performance requirement of the electric motor, and further have low material cost, high die casting qualification rate and production efficiency.

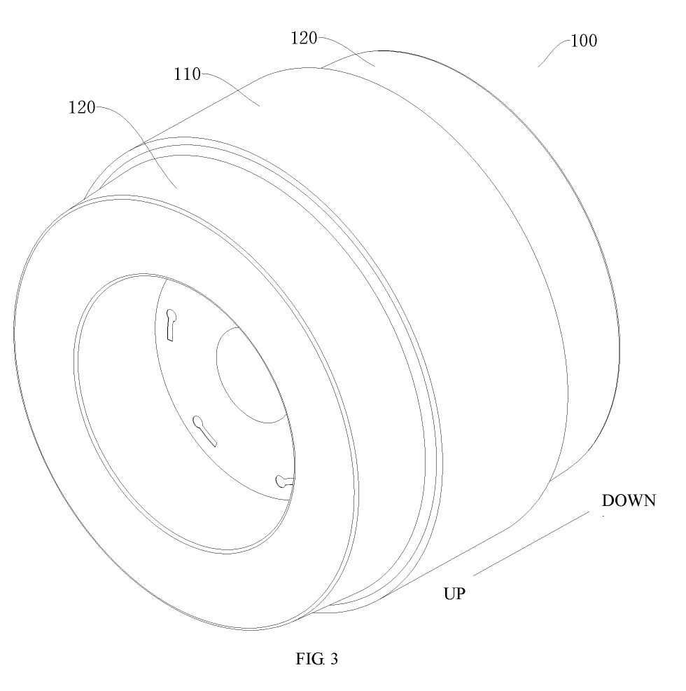

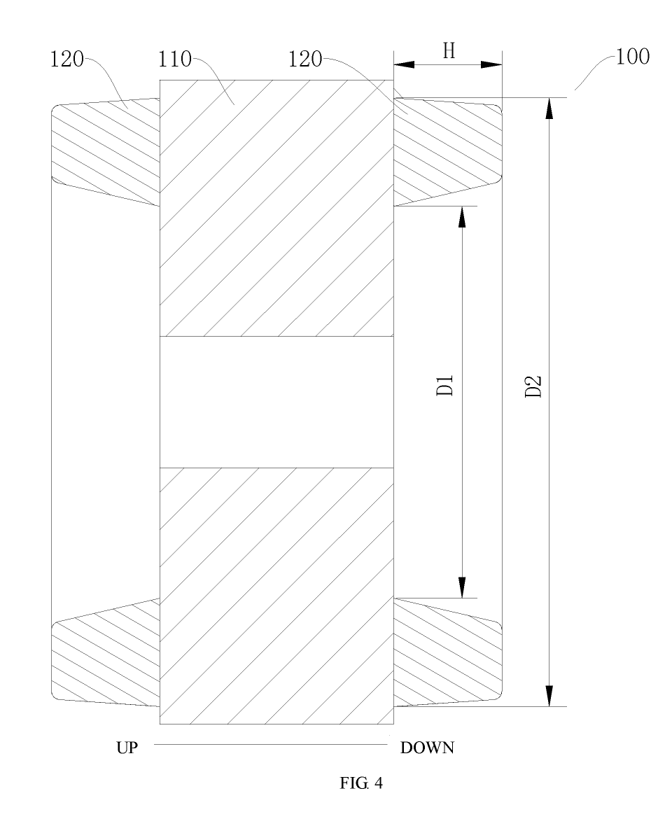

As shown in FIGS. 3 and 4, according to some embodiments of the present invention, at least one of an inner circumferential surface, an outer circumferential surface, and an end surface, far away from the rotor core 110, of the squirrel-cage short-circuit ring 120 is provided with the dynamic balance lightening hole to achieve the dynamic balance processing for the electric motor. In other words, the dynamic balance lightening hole may be provided in the inner circumferential surface or the outer circumferential surface of the squirrel-cage short-circuit ring 120; alternatively the dynamic balance lightening hole may be provided in the end surface, far away from the rotor core 110, of the squirrel-cage short-circuit ring 120; of course, the dynamic balance lightening hole may also be provided in the inner circumferential surface, the outer circumferential surface and the end surface, far away from the rotor core 110, of the squirrel-cage short-circuit ring 120 at the same time.

It should be understood that, the end surface, far away from the rotor core 110, of the squirrel-cage short-circuit ring 120 located above refers to an upper end surface thereof, and the end surface, far away from the rotor core 110, of the squirrel-cage short-circuit ring 120 located below refers to an lower end surface thereof.

Alternatively, the dynamic balance lightening hole may be a round hole with a diameter of 3 to 6 mm, which thus may meet the lightening requirement of the high-precision dynamic balance, and is convenient to be processed and formed. Preferably, the dynamic balance lightening hole may be provided in at least one of the inner circumferential surface and the outer circumferential surface of the squirrel-cage short-circuit ring 120, i.e. the dynamic balance lightening hole may be provided in the inner circumferential surface or the outer circumferential surface of the squirrel-cage short-circuit ring 120; alternatively the inner circumferential surface and the outer circumferential surface of the squirrel-cage short-circuit ring 120 are provided with the dynamic balance lightening hole separately, in which the diameter of the dynamic balance lightening hole is 5 mm, such that the precision of the dynamic balance is higher.

In some embodiments of the present invention, the height H of the squirrel-cage short-circuit ring 120 in the axial direction of the rotor core 110 may be 12 mm, and the ratio D1/D2 of the minimum inner diameter of the squirrel-cage short-circuit ring 120 to the maximum outer diameter of the squirrel-cage short-circuit ring 120 may be 0.66, such that the material cost of the squirrel-cage short-circuit ring 120 is optimal, the qualification rate and the production efficiency thereof are the best, and the performance of the electric motor is more excellent.

According to some embodiments of the present invention, as shown in FIG. 4, a cross section of the squirrel-cage short-circuit ring 120 may be a trapezoid. Further, a long base of the trapezoid is adjacent to the rotor core 110, and a short base of the trapezoid is far away from the rotor core 110, i.e. a radial cross sectional area of the squirrel-cage short-circuit ring 120 gradually decreases from one end adjacent to the rotor core 110 to the other end far away from the rotor core 110 in an axial direction of the squirrel-cage short-circuit ring 120. The minimum inner diameter D1 of the squirrel-cage short-circuit ring 120 is an inner diameter of the end of the squirrel-cage short-circuit ring 120 adjacent to the rotor core 110, and the maximum outer diameter D2 is an outer diameter of the other end of the squirrel-cage short-circuit ring 120 far away from the rotor core 110.

According to some embodiments of the present invention, the squirrel-cage guide bar may be oriented in the axial direction of the rotor core 110, which thus facilitates the production, processing and assembling thereof. For example, the squirrel-cage guide bar extends in the up-and-down direction. Of course, the squirrel-cage guide bar may be inclined with respect to the axial direction of the rotor core 110, which thus effectively weakens an additional torque caused by a tooth harmonic magnetic field, and reduces electromagnetic vibrations and noises.

According to some embodiments of the present invention, the rotor core 110 is formed by laminating a plurality of rotor punching sheets 112, such that the performance of the electric motor is excellent and the production cost thereof is low. It should be understood that, each rotor punching sheet 112 is provided with a punching groove 1120 penetrating therethrough in the up-and-down direction, and the rotor groove 111 is formed by laminating the punching grooves 1120 of the plurality of the rotor punching sheets 112. Preferably, the squirrel-cage guide bar and the squirrel-cage short-circuit ring 120 may be formed integrally, which thus facilitates the assembling and saves the production cost.

Hereinafter, a squirrel-cage rotor 100 according to a specific embodiment of the present invention will be described in detail with reference to the accompanying drawings, and it should be understood that, the following description is only an exemplary illustration, and shall not be construed to limit the present disclosure.

As shown in FIGS. 1 to 5, the squirrel-cage rotor 100 according to the embodiment of the present invention, includes the rotor core 110, the squirrel-cage guide bar and the squirrel-cage short-circuit ring 120.

Specifically, the rotor core 110 is formed by laminating the plurality of rotor punching sheets 112, each rotor punching sheet 112 is provided with a plurality of punching grooves 1120 penetrating therethrough in the up-and-down direction, and the plurality of punching grooves 1120 are equidistantly spaced in a circumferential direction of the rotor punching sheet 112 where they are located. The punching grooves 1120 of the plurality of the rotor punching sheets 112 are laminated and form a plurality of rotor grooves 111. A plurality of squirrel-cage guide bars are provided in the plurality of rotor grooves 111 respectively. Both upper and lower end surfaces of the rotor core 110 are provided with the squirrel-cage short-circuit ring 120 made of aluminum separately, the cross section of the squirrel-cage short-circuit ring 120 is the trapezoid, the long base of the trapezoid is more adjacent to the rotor core 110 than the short base thereof, and the two squirrel-cage short-circuit rings 120 and the plurality of squirrel-cage guide bars are formed integrally. The height H of the squirrel-cage short-circuit ring 120 in the up-and-down direction is 12 mm, the minimum inner diameter of the squirrel-cage short-circuit ring 120 is D1, the maximum outer diameter of the squirrel-cage short-circuit ring 120 is D2, the ratio D1/D2 of the minimum inner diameter to the maximum outer diameter of each squirrel-cage short-circuit ring 120 is 0.66, and the dynamic balance lightening hole is a round hole with a diameter of 5 mm and is provided in the outer circumferential surface of the squirrel-cage short-circuit ring 120.

The squirrel-cage rotor 100 according to embodiments of the present invention, the height H in the up-and-down direction and the thickness of the squirrel-cage short-circuit ring 120 thereof in the radial direction of the rotor core 110 are smaller than those of the squirrel-cage short-circuit ring in the related art, such that the squirrel-cage rotor 100 may not only meet the lightening requirement of the dynamic balance, but also meet the performance requirement of the electric motor, and further the amount of aluminum used is the least, the die casting mold may achieve six cavities, thereby achieving the optimal material cost, die casting qualification rate and production efficiency.

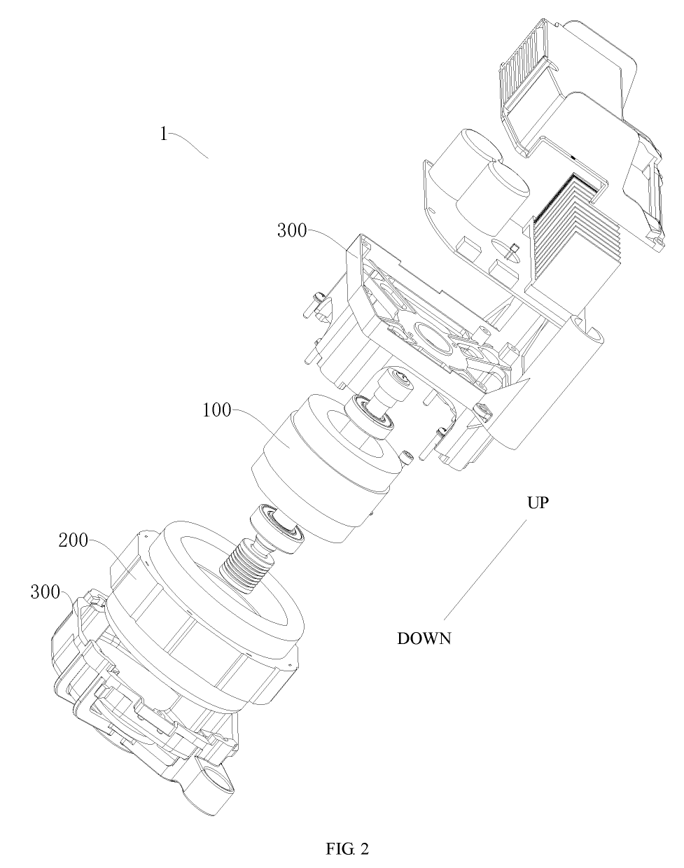

As shown in FIGS. 1 and 2, an electric motor 1 according to embodiments of a second aspect of the present invention, is used in a washing machine, and is configured as a high-speed low-vibration variable frequency electric motor, specifically including a stator 200, a rotor and at least one end cap 300. The rotor is configured as the squirrel-cage rotor 100 according to the above-described embodiments of the present invention, and the squirrel-cage rotor 100 is rotatably provided in stator 200. For example, the squirrel-cage rotor 100 is provided in the stator 200, two end caps 300 are provided and located at an upper end surface of the stator 200 and a lower end surface of the stator 200 respectively to mount the stator 200 and the squirrel-cage rotor 100.

The electric motor 1 according to embodiments of the present invention, by utilizing the above-described squirrel-cage rotor 100, may meet dynamic balance processing requirements, and have an excellent performance, a low material cost, a high die casting qualification rate and production efficiency.

A washing machine according to embodiments of a third aspect of the present invention, includes a rotatable dewatering tub and an electric motor, in which the electric motor is configured as the electric motor 1 according to the above-described embodiments of the present invention, and the electric motor 1 is in a transmission connection with the dewatering tub via a transmission belt to drive the dewatering tub to rotate.

The washing machine according to embodiments of the present invention, by utilizing the above-described electric motor 1, may achieve small noises and vibrations, and a long service life.

In the description of the present disclosure, it should be understood that, terms such as “thickness”, “upper”, “lower”, “bottom”, “inner”, “outer”, “axial”, “radial” should be construed to refer to the orientation as then described or as shown in the drawings under discussion for simplifying the description of the present disclosure, but do not alone indicate or imply that the device or element referred to must have a particular orientation, or must be constructed or operated in a particular orientation, which shall not be construed to limit the present disclosure. In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, “a plurality of” means two or more than two, unless specified otherwise.

In the present invention, unless specified or limited otherwise, the terms “mounted,” “connected,” “coupled,” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

Reference throughout this specification to “an embodiment,” “some embodiments,” “a specific embodiment”, “an example,” “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that changes, modifications, alternatives, and variations can be made in the embodiments without departing from principles and spirit of the present disclosure. The scope of the present disclosure is defined by the claims and their equivalents.

1. A squirrel-cage rotor, comprising:
a rotor core provided with a rotor groove penetrating through an end surface of the rotor core;
a squirrel-cage guide bar provided in the rotor groove; and
a squirrel-cage short-circuit ring providing on the end surface of the rotor core and connected to the squirrel-cage guide bar, wherein a height of the squirrel-cage short-circuit ring in an axial direction of the rotor core is denoted as H, a minimum inner diameter of the squirrel-cage short-circuit ring is denoted as D1, a maximum outer diameter of the squirrel-cage short-circuit ring is denoted as D2, and 7 mm≦H≦14 mm, 0.53≦D1/D2≦0.78.

2. The squirrel-cage rotor according to claim 1, wherein at least one of an inner circumferential surface, an outer circumferential surface, and an end surface, far away from the rotor core, of the squirrel-cage short-circuit ring is provided with a dynamic balance lightening hole.

3. The squirrel-cage rotor according to claim 2, wherein a diameter of the dynamic balance lightening hole is 3 to 6 mm.

4. The squirrel-cage rotor according to claim 3, wherein the dynamic balance lightening hole is provided in at least one of the inner circumferential surface and the outer circumferential surface of the squirrel-cage short-circuit ring, and the diameter of the dynamic balance lightening hole is 5 mm.

5. The squirrel-cage rotor according to claim 1, wherein the height H of the squirrel-cage short-circuit ring in the axial direction of the rotor core is 12 mm, and the ratio D1/D2 of the minimum inner diameter of the squirrel-cage short-circuit ring to the maximum outer diameter of the squirrel-cage short-circuit ring is 0.66.

6. The squirrel-cage rotor according to claim 1, wherein a cross section of the squirrel-cage short-circuit ring is a trapezoid.

7. The squirrel-cage rotor according to claim 5, wherein a long base of the trapezoid is adjacent to the rotor core, and a short base of the trapezoid is far away from the rotor core.

8. The squirrel-cage rotor according to claim 1, wherein the squirrel-cage guide bar is oriented in the axial direction of the rotor core or is inclined with respect to the axial direction of the rotor core.

9. The squirrel-cage rotor according to claim 1, wherein the squirrel-cage guide bar and the squirrel-cage short-circuit ring are formed integrally.

10. The squirrel-cage rotor according to claim 1, wherein the rotor core is formed by laminating a plurality of rotor punching sheets.

11. An electric motor, comprising:
a stator;
a rotor, wherein the rotor is a squirrel-cage rotor comprising:
a rotor core provided with a rotor groove penetrating through an end surface of the rotor core;
a squirrel-cage guide bar provided in the rotor groove; and
a squirrel-cage short-circuit ring providing on the end surface of the rotor core and connected to the squirrel-cage guide bar, wherein a height of the squirrel-cage short-circuit ring in an axial direction of the rotor core is denoted as H, a minimum inner diameter of the squirrel-cage short-circuit ring is denoted as D1, a maximum outer diameter of the squirrel-cage short-circuit ring is denoted as D2, and 7 mm≦H≦14 mm, 0.53≦D1/D2≦0.78, and the squirrel-cage rotor is rotatably provided in the stator; and
at least one end cap for mounting the stator and the rotor.

12. A washing machine, comprising:
a rotatable dewatering tub; and
an electric motor comprising:
a stator;
a rotor, wherein the rotor is a squirrel-cage rotor comprising:
a rotor core provided with a rotor groove penetrating through an end surface of the rotor core;
a squirrel-cage guide bar provided in the rotor groove; and
a squirrel-cage short-circuit ring providing on the end surface of the rotor core and connected to the squirrel-cage guide bar, wherein a height of the squirrel-cage short-circuit ring in an axial direction of the rotor core is denoted as H, a minimum inner diameter of the squirrel-cage short-circuit ring is denoted as D1, a maximum outer diameter of the squirrel-cage short-circuit ring is denoted as D2, and 7 mm≦H≦14 mm, 0.53≦D1/D2≦0.78, and the squirrel-cage rotor is rotatably provided in the stator; and
at least one end cap for mounting the stator and the rotor;
wherein the electric motor is in a transmission connection with the dewatering tub to drive the dewatering tub to rotate.

13. The electric motor according to claim 11, wherein at least one of an inner circumferential surface, an outer circumferential surface, and an end surface, far away from the rotor core, of the squirrel-cage short-circuit ring is provided with a dynamic balance lightening hole.

14. The electric motor according to claim 13, wherein a diameter of the dynamic balance lightening hole is 3 to 6 mm.

15. The electric motor according to claim 14, wherein the dynamic balance lightening hole is provided in at least one of the inner circumferential surface and the outer circumferential surface of the squirrel-cage short-circuit ring, and the diameter of the dynamic balance lightening hole is 5 mm.

16. The electric motor according to claim 11, wherein the height H of the squirrel-cage short-circuit ring in the axial direction of the rotor core is 12 mm, and the ratio D1/D2 of the minimum inner diameter of the squirrel-cage short-circuit ring to the maximum outer diameter of the squirrel-cage short-circuit ring is 0.66.

17. The electric motor according to claim 11, wherein a cross section of the squirrel-cage short-circuit ring is a trapezoid.

18. The electric motor according to claim 17, wherein a long base of the trapezoid is adjacent to the rotor core, and a short base of the trapezoid is far away from the rotor core.

19. The electric motor according to claim 11, wherein the squirrel-cage guide bar is oriented in the axial direction of the rotor core or is inclined with respect to the axial direction of the rotor core.

20. The electric motor according to claim 11, wherein the squirrel-cage guide bar and the squirrel-cage short-circuit ring are formed integrally.
